(19) United States
(12) Patent Application Publication
(10) Pub. No.: US 2026/0267010 A1
(43) Pub. Date: Sep. 10, 2026

(54) METHOD AND APPARATUS FOR PERFORMING MOTION COMPENSATED RADIO SIGNAL PROCESSING WHEN A RECEIVING ANTENNA IS STATIONARY

(71) Applicant: FOCAL POINT POSITIONING LIMITED, Cambridge (GB)

(72) Inventors: Ramsey Michael FARAGHER, Cambridge (GB); Robert Mark CROCKETT, Cambridge (GB); Peter James DUFFETT-SMITH, Cambridge (GB)

(21) Appl. No.: 19/165,977

(22) PCT Filed: May 3, 2024
(86) PCT No.: PCT/EP2024/062317

§ 371 Date: Sep. 16, 2025

Related U.S. Application Data
(60) Provisional application No. 63/463,779, filed on May 3, 2023.

(51) Int. Cl. G01S 19/42; G01S 5/02

(52) U.S. Cl. CPC G01S 19/428; G01S 5/0273

(57) ABSTRACT

A method and apparatus for determining position and/or time for user equipment using radio signals that are reflected from moving reflectors include receiving a plurality of reflected signals having different propagation paths, determining a motion of a moving reflector, generating a plurality of phasors sequences, where each phasor sequence represents a hypothesis based on reflector motion and a user equipment position estimate for each of the plurality of the received signals, compensating the received signals, a plurality of local signals or correlation results from correlating the received signals with the local signals using the plurality of phasor sequences to generate a plurality of compensated correlation results, identifying a preferred hypothesis in the plurality of hypotheses, for each received signal, that optimizes at least one correlation result in the plurality of compensated correlation results, and using the optimized at least one correlation result to determine a user equipment position time.

### BACKGROUND

### Field

Embodiments of the present principles generally relate to radio signal processing and, in particular, to a method and apparatus for performing motion compensated radio signal processing when a receiving antenna is stationary.

### Description of the Related Art

Radio signal transmissions are used in various communications and positioning systems. For example, WiFi, using the IEEE 802.11a, b, g, n, ac standards, has become ubiquitous for short range data communications. WiFi access points (also referred to as WiFi hotspots) comprise radio transceivers that broadcast 2.4 GHz or 5 GHz signals using a narrowband signal (e.g., 22 MHz). Cellular telephone signals for GPRS, GSM, etc. are used for communications among cellular telephones and associated base stations. Global Navigation Satellite System (GNSS) receivers are included in many electronic devices, including smartphones, to determine the geolocation of the device. GNSS receivers operate using signals from satellites in one or more of the commercially available GNSS satellite systems, including GPS, GLONASS, BeiDou, etc. The receivers for one or more of these systems can be included in user equipment (UE) such as laptop computers, cellular telephones, tablets, Internet of Things (IoT) devices, positioning devices, and the like.

All of the communications and positioning systems described above utilize transmitted signals that can experience multipath interference resulting from signal reflections from buildings, mountains, vehicles, walls, etc. A receiver typically receives a direct signal (i.e., line-of-sight (LOS) signal) that propagates from the transmitter to the receiver and can receive one or more indirect signals (i.e., non-line-of-sight (NLOS) signal(s)) that are reflected versions of the direct signal that can be reflected one or more times before reaching the receiver. The indirect signals are delayed during a propagation path when compared to the arrival time of a direct signal. Consequently, the indirect signals interfere with the reception of the direct signal. In some instances, a receiver can only receive indirect signals because an object such as a building may impede the direct signal propagation path.

Generally however, a receiver receives both indirect and direct signals and processes all the received signals to extract data from the signals. If the multipath interference is significant, the receiver may miss some data and/or lose position for a period of time. With a moving receiver, the interference is generally intermittent and constantly changing.

A technique is available for selecting signals having the best characteristics for processing. The technique can also enhance signal reception for certain signals (e.g., direct signals) and suppress signal reception for other signals (e.g., indirect signals). The technique for performing signal differentiation using receiver motion information is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; US patent publication 2020/0319347, published 8 Oct. 2020, and US patent publication 2024/0045077, published 8 Feb. 2024, which are hereby incorporated herein by reference in their entireties. However, SUPERCORRELATION™ relies upon motion compensated signal processing in instances in which the receiver and, more specifically, the receiver antenna, must be moving to facilitate signal differentiation (i.e., the receiver is moving through the multipath environment produced by the signals). When the receiver antenna ceases moving, the motion compensated signal processing is unable to differentiate the direction of arrival of the signals.

It would be advantageous to improve motion compensated signal processing to enable the SUPERCORRELATION™ technique to function when the receiver antenna is not moving. Therefore, there is a need for a method and apparatus for performing motion compensated radio signal processing when a receiver/receiver's antenna is stationary.

### SUMMARY

Embodiments of the present principles generally relate to a method and apparatus for performing motion compensated radio signal processing when a receiving antenna is stationary as shown in and/or described in connection with at least one of the figures and description herein.

These and other features and advantages of the present principles can be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a particular description of the invention can be understood by reference to embodiments, some of which are illustrated in the appended drawings. It is to be noted, however, that the appended drawings illustrate only typical embodiments of the present principles and are therefore not to be considered limiting of its scope, for embodiments of the present principles can function with other equally effective embodiments.

FIG. 1 depicts a block diagram of a communication environment having user equipment that receives signals transmitted by a one or more transmitters in which the user equipment is stationary in accordance with at least one embodiment of the present principles;

FIG. 2 depicts a block diagram of the user equipment of FIG. 1 in accordance with at least one embodiment of the present principles;

FIG. 3 depicts a flow diagram of a method of operation of the static software executed by the user equipment of FIG. 1 in accordance with at least one embodiment of the present principles; and

FIG. 4 is a graphical depiction of signal convergence resulting from the operation of the method of FIG. 3 in accordance with at least one embodiment of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of the present principles generally relate to methods and apparatuses for performing motion compensated radio signal processing when a receiver/receiving antenna is stationary. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific radio signals originating from specific transmitters and being received by specific receivers, embodiments in accordance with the present principles can be applied to substantially any radio signals originating from substantially any transmitter and being received by substantially any receiver.

Embodiments of the present principles include apparatuses and methods for performing motion compensated radio signal processing when a receiving antenna is stationary. In some embodiments, SUPERCORRELATION™ techniques are utilized to motion compensate for the motion of at least one radio signal reflector and process reflected signals from the moving reflector to determine the position of the user equipment and/or determine an accurate time reference for use by the user equipment. The SUPERCORRELATION™ technique typically exploits the motion of a receiver antenna through space; however, embodiments of the present principles use the SUPERCORRELATION™ technique to exploit the motion of reflectors within the environment moving relative to a stationary receiver antenna.

Digital communications systems, such as cellular, Bluetooth or WiFi, and positioning systems, such as GNSS, utilize encoded digital radio signals to improve signal throughput and security. These systems use some form of deterministic digital code to facilitate signal acquisition, e.g., acquisition codes such as Gold codes, Barker codes, etc. Such a digital code is deterministic by the receiver and repeatedly broadcast by the transmitter to enable the receivers to acquire and receive the transmitted signals. Using such deterministic codes combined with an accurate motion model of a reflector, embodiments of the present prinicples are useful for determining position and/or accurate time (e.g., clock frequency) through processing reflected radio signals. The technique for performing this position/time determination using motion information to accurately process signals is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; US patent publication 2020/0319347, published 8 Oct. 2020, and US patent publication 2024/0045077, published 8 Feb. 2024, which are hereby incorporated herein by reference in their entireties. As mentioned above, typically, the SUPERCORRELATION™ technique does not function while the receiver/receiver antenna is stationary. To overcome this limitation, embodiments of the present principles rely upon moving radio signal reflectors to cause changes in the multipath environment to enable SUPERCORRELATION™ to function while the receiver antenna is stationary. If the user equipment has knowledge of the reflector characteristics (e.g., direction, velocity and position), the SUPERCORRELATION™ technique can be applied to the received signal in its normal manner. However, rather than compensating for antenna motion, in accordance with the present principles, the technique compensates for reflector motion.

In one exemplary embodiment, a receiver carried by a platform can be transported through a space containing a transmitter (e.g., but not limited to, WiFi, Bluetooth, cellular, GNSS, etc.) and be able to accurately receive signals reflected from moving reflectors. With knowledge of the motion characteristics of the reflector (e.g., time, position, velocity and direction of movement), knowledge of the transmitter location and a general estimate of the receiver antenna position, embodiments of the present principles accurately determine the receiver antenna position and/or determine an accurate time reference (e.g., actual time of day based on knowing the frequency offset of the clock that is determined using supercorrelation). In some embodiments, receiver and reflector positions can be a priori provided or can be determined by the receiver. In some embodiments, reflector information can be contained in a database of moving reflector positions and motion characteristics. For example, a plurality of rotating, windmill-like reflectors can be positioned on light poles where the reflector rotates at a known speed. In other embodiments, the reflector motion information can be known to the reflector (e.g., a vehicle) and broadcast via IoT device to the user equipment. In such embodiments, the IoT devices can form part of a connected city or smart city.

In some embodiments, the positions can be absolute (world geographic coordinates) or can be relative (arbitrary coordinate system). The functions of embodiments of the present principles can be embedded into cellular telephones, Internet of Things (IOT) devices, mobile computers, tablets, communication channel analyzers, and the like (i.e., user equipment). Embodiments find use with any user equipment that receives signals having a code that can be correlated with a locally generated code. The user equipment need only be able to utilize a deterministic acquisition code contained in the received signal. Although the user equipment can receive the signal and utilize a full data message of the signal (i.e., WiFi, Bluetooth, GNSS or cellular enabled), the user equipment does not have to be fully enabled to be used in embodiments of the present principles.

Some embodiments of the present principles can perform the signal processing locally on the platform (user equipment). Alternatively or in addition, in some embodiments, the reflector motion information and received signal information can be gathered at the platform and communicated (wired or wirelessly) to a server for remote processing in real-time or at a later time.

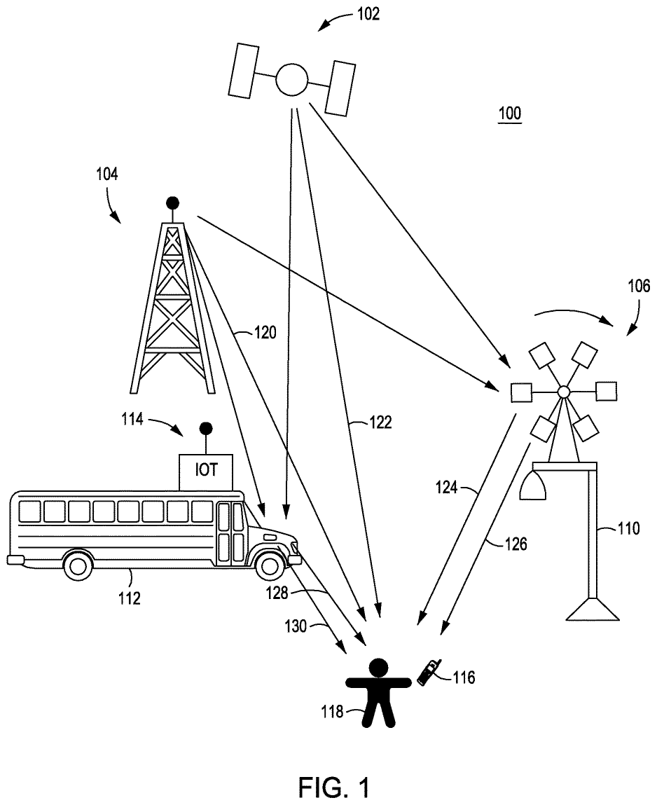

FIG. 1 depicts a block diagram of a communication environment 100 having user equipment 116 that receives signals transmitted by a one or more transmitters 102, 104 in which the user equipment is stationary in accordance with at least one embodiment of the present principles. As the at least one user equipment 116 moves (i.e., being carried by person 118), the user equipment 116 receives signals from the at least one signal transmitter(s) 102, 104. In the communication environment 100 of FIG. 1, the at least one user equipment 116 is operating in a high multipath environment such as between buildings (i.e., an urban canyon).

In the embodiment shown in FIG. 1, the user equipment 116 moves through the area knowing its position estimate either from: (1) a global navigation satellite (GNSS)receiver and/or an inertial navigation system (INS) or (2) position knowledge from a map or visual odometry/positioning (e.g., knowledge of landmarks with known locations within the area). As depicted in the communication environment of 100 of FIG. 1, signals from the transmitters 102, 104 propagate along direct paths 120, 122 and indirect paths 124, 126, 128. For example, signals transmitted from transmitter 102 (e.g., a GNSS satellite) travel to the user equipment 116, for example, along a direct path 122 and two indirect paths 124 and 128. The indirect paths are formed by the signals reflecting from the moving vehicle (e.g., bus 112) and a moving reflector 106 mounted to, for example, a lamp post 110. In some embodiments, the moving reflectors 112, 106 can include an Internet of Things (IoT) device 114 to transmit the reflector's velocity, position, and/or heading to the user equipment 116. Similarly, signals from the transmitter 104 (e.g., a cellular telephone base station) propagate to the user equipment 116 along paths 120, 126 and 130.

The moving reflectors 112, 106 of FIG. 1 can be any form of reflector in which the user equipment has knowledge of the motion characteristics of the reflector. For example, a vehicle can have an IoT device that monitors the vehicle's position, velocity and heading and broadcasts that information to the user equipment. In other embodiments, the motion information can be broadcast to a network for distribution to the user equipment by a central server. In other embodiments, the moving reflector can be purpose built for supporting the SUPERCORRELATION™ technique. For example, in some embodiments the reflector can be fixed to a structure such as a telephone pole, lamp post, building, etc., however, the reflector can have a moving portion that moves in a known manner (e.g., a spinning windmill-like reflector, that rotates at a speed that is known to the user equipment). In some embodiments, the reflector position and motion information can be known to the user equipment via a database and/or the position and motion information can be broadcast by a communications unit at each reflector. In some embodiments, other forms of moving reflectors can include drones and/or other forms of manned or unmanned aircraft.

To implement the user equipment 116 to determine accurate position and/or accurate time derived from the received reflected signals while the user equipment is stationary requires knowledge of the motion characteristics of the reflectors 112 and 106. The communication environment 100 of FIG. 1 illustratively includes two known reflectors; however, in a typical scenario in a city, many moving and stationary reflectors can exist. The user equipment of the present principles, as is described below, is capable of discriminating between the signals being received from known moving reflectors and stationary reflectors.

As described in detail below, the at least one user equipment 116 uses a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; US patent publication 2020/0319347, published 8 Oct. 2020, and US patent publication 2024/0045077, published 8 Feb. 2024, which are hereby incorporated herein by reference in their entireties. The technique is used in the determination of a position and/or a time reference by using motion compensation to identify and isolate the reflected signals and process those signals using joint correlation of multiple received signals. Once the user equipment 116 stops moving, the user equipment determines motion information representing motion of the reflectors. The motion information is used to perform motion compensated correlation of the received signals. From the motion compensated correlation process, the user equipment estimates the user equipment position and/or time.

In one embodiment of the present principles, the user equipment 116 can be carried by a person 118 or be mounted in a vehicle. In such instances, the user equipment 116 is designed to intermittently move and stop. User equipment 116, can comprise any type of communications or positioning devices. Alternatively or in addition, in some embodiments, the user equipment can be in a fixed location, such as a time reference device for a communications system base station (i.e., a time reference for a cellular base station).

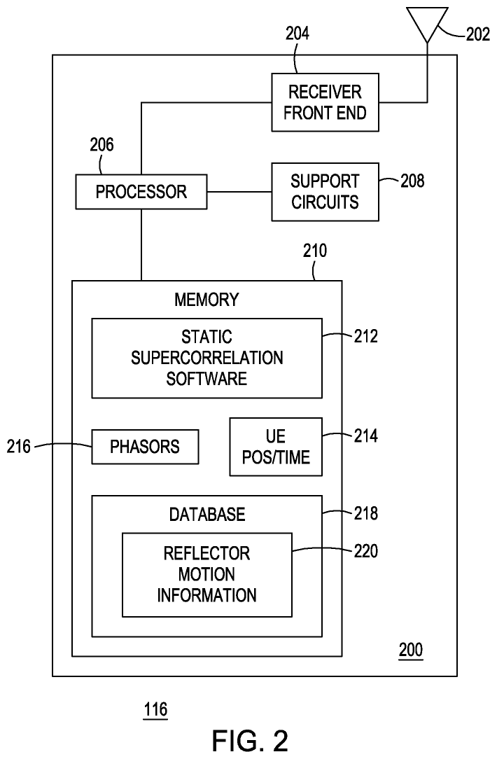

FIG. 2 is a block diagram of the user equipment 116 in accordance with at least one embodiment of the present principles. The user equipment 116 of FIG. 2 illustratively comprises a mobile platform 200, an antenna 202, a receiver front end 204, a processor 206, support circuits 208 and a memory 210. In some embodiments, the user equipment 116 can form at least a portion of a laptop computer, mobile phone, tablet computer, Internet of Things (IoT) device, purpose built positioning device, and the like. Alternatively or in addition, in some the platform 200 is not the mobile, but rather a stationary platform of a time reference device.

Typically, the platform 200 and the antenna 202 are an indivisible unit in which the antenna 202 moves with the platform 200. In embodiment described herein, the operation of the SUPERCORRELATION™ technique operates based upon determining the reflector motion relative to the stationary receiving antenna. Any mention of motion herein refers to the relative motion of the reflectors with respect to the antenna 202. In most scenarios, the relative motion of the platform 200 is the same as the relative motion of the antenna 202 with respect to the reflectors and, as such, the following description will assume that the platform 200 and antenna 202 are stationary at the same time.

In the embodiment of FIG. 2, the mobile platform 200 comprises a receiver front end 204, at least one processor 206, support circuits 208 and memory 210. The receiver front end 204 down-converts, filters, and samples (digitizes) the received signals in a manner that is well-known to those skilled in the art. The output of the receiver front end 204 is a digital signal containing data. The data of interest is a deterministic training or acquisition code used by the transmitter to synchronize the transmission to a receiver (e.g., a WiFi transceiver, GNSS transmitter, cellular base station, etc.).

The at least one processor 206 can include form of processor or combination of processors including, but not limited to, central processing units, microprocessors, microcontrollers, field programmable gate arrays, graphics processing units, digital signal processors, and the like. The support circuits 208 can include well-known circuits and devices facilitating functionality of the processor(s). The support circuits 208 can include one or more of, or a combination of, power supplies, clock circuits, analog to digital converters, communications circuits, cache, displays, and/or the like.

In some embodiments, the memory 210 can include one or more forms of non-transitory computer readable media including one or more of, or any combination of, read-only memory or random-access memory. The memory 210 stores software and data including, for example, static SUPERCORRELATION™ software 212, reflector motion compensation phasor(s) 216, receiver position and/or time and a database 218. The database 218 can store reflector motion information 220 as well as various other data used to perform the SUPERCORRELATION™ processing. The static SUPERCORRELATION™ software 212, when executed by the one or more processors 208, performs motion compensated correlation upon the received reflected signals to estimate the user equipment position and/or time. The motion compensated correlation process is described in detail below.

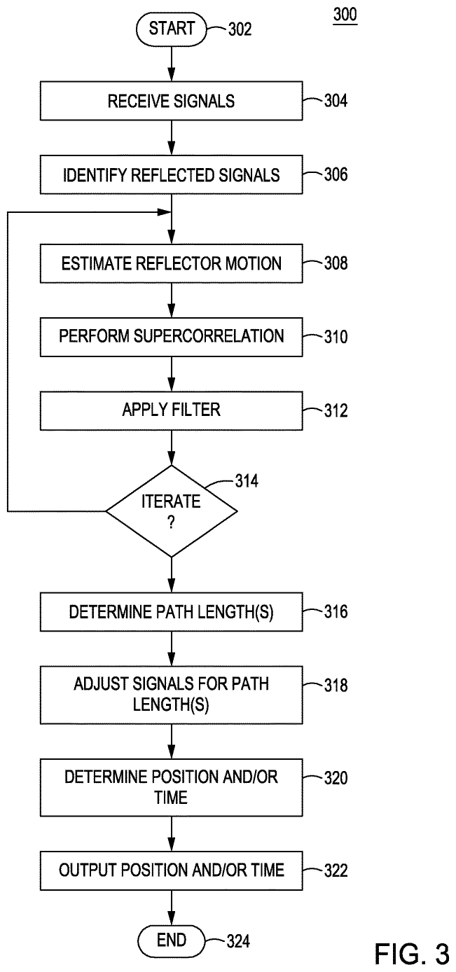

FIG. 3 is a flow diagram of a method 300 of operation for the static SUPERCORRELATION™ software 216 in accordance with at least one embodiment of the present principles. In some embodiments, the method 300 can be implemented in software, hardware or a combination of both (e.g., using the at least one processor 208 of FIG. 2). The method 300 processes reflected signals from the known moving reflectors to (1) determine an accurate motion (velocity, position, heading) of the moving reflector, (2) determine and compensate for the path length of the reflected signals compared to the path length of direct signals, and (3) use the compensated signals in a position computation to determine the position of the user equipment. Alternatively or in addition, the compensated signals can be used in a computation of accurate time.

The method 300 can begin at 302 and proceeds to 304 where signals are received at a receiver from a remote source (e.g., transmitter 102, 104) in a manner as described with respect to FIG. 1. Each received signal can include a synchronization or acquisition code (i.e., a deterministic code, extracted from the radio frequency (RF) signal received at the antenna of the user equipment 116). The RF signal can then be down-converted. The process of down-converting the RF signal and extracting the digital code is well known in the art and as such will not be described in detail herein.

The method 300 can proceed to 306. At 306, the method 300 identifies the reflected signals. In one embodiment, the reflected signal can be a time delayed replica of a direct signal. As such, in some embodiments using signal matching techniques to compare the direct signal to the delayed signal can identify a reflected signal. In some embodiments, to differentiate between reflection from moving reflectors and stationary reflectors, embodiments of the present principles can implement additional information. For example, in some embodiments of the present principles (i.e., at 306), the user equipment can include or have access to a database comprising reflector information. The reflector information may include a position, velocity and heading of one or more moving reflectors. For example, a moving reflector may be a bus comprising an IoT device (e.g., bus 112 with IoT device 114) that reports the vehicle's current position, velocity and/or heading. Using such information, the user equipment of the present principles can estimate the motion induced phase change and the direction of arrival of the signal. Additionally, knowledge of the reflector enables the determination of an initial estimate of the time delay relative to the direct signal imparted to the reflected signal via the longer propagation path. To accurately process the reflected signal, the time delay and the reflector motion must be compensated for.

For example, in some embodiments, the time delay is determined through knowledge of the transmitter location (e.g., GNSS satellite ephemeris, known cellular base station locations, WiFi hotspot transmitter locations, etc.), knowledge of the reflector motion, and an estimate of the user equipment position. A ray tracing model can then be used to determine the propagation path of the reflected signal and compare the path length to the direct signal path length. The method 300 can proceed to 308.

At 308, the reflector motion (e.g., receives an estimate from a database) is estimated as a motion hypothesis. The method 300 can proceed to 310.

At 310, a SUPERCORRELATION™ technique is performed on the reflected signals. The method 300 can proceed to 312.

At 312, a least squares fit (LSF), Baysian estimator, Kalman filter, and/or particle filter algorithm can be applied to accurately determine the reflector motion (e.g., position, velocity, heading). Since the database motion estimate was collected in the past, the motion value is only an estimate. By the application of the SUPERCORRELATION™ technique and a filtering algorithm to the motion estimates, an accurate motion value can be generated. The method 300 can proceed to 314.

At 314, it is determined whether the motion calculation should iterate through the motion computation (functions 308, 310 and 312) to further correct the motion value. If the determination is affirmatively answered, the method 300 iterates for additional accuracy and returns to 308. If the determination is negatively answered, the method 300 proceeds to 316 (316 described further below).

In accordance with the present principles, the determined motion value can be used to accurately calculate the reflected path time delay and can also be used by the SUPERCORRELATION™ technique to produce a plurality of phasor sequence hypotheses to motion compensate the reflected signal. More specifically, the SUPERCORRELATION™ technique uses a plurality of phasor sequence hypotheses related to a direction of interest of the received signal (e.g., direction of the one or more reflections to be used in the position or time solution). These hypotheses comprise a plurality of local signals representing the phase of the carrier signal. In some embodiments of the present principles, the object is to compensate the carrier phase to achieve an improved measurement of the code phase/pseudorange.

In some embodiments, each phasor sequence hypothesis comprises a series of phase offsets that vary with parameters of the reflector such as motion. The signal processing correlates a local code encoded in a local signal with a code encoded in the received RF signal. In one embodiment, the phasor sequence hypotheses are used to adjust, at a sub-wavelength accuracy, the carrier phase of the local signal over one or more periods (lengths) of the code. Such adjustment or compensation can be performed by adjusting a local oscillator signal, the received signal(s), or the correlation result to produce a phase compensated correlation result. The signals and/or correlation results are complex signals comprising in-phase (I) and quadrature phase (Q) components. In some embodiments, each phase offset in the phasor sequence is applied to a corresponding complex sample in the signals or correlation results. If the phase adjustment is or includes an adjustment for receiver motion and/or reflector motion, then the result is a motion compensated correlation result. In some embodiments, at 310, for each received reflected signal, the received signals can be correlated with a set (plurality) of direction hypotheses containing estimates of a phase offset necessary to accurately correlate the received signals arriving from particular directions. As such, there is a set of hypotheses representing a search space for each received signal and reflector motion estimate.

In some embodiments, since the signal is received from a single transmitter, the set of hypotheses for newly received signals from the transmitter include a group of phasor sequence hypotheses using the expected Doppler and Doppler rate and/or last Doppler and last Doppler rate used in receiving the prior signal from that transmitter. The values can be centered around the last values used or the last values used additionally offset by a prediction of further offset based on the expected reflector motion.

Referring back to 310, in some embodiments at 310 each received signal is correlated with that signal's set of hypotheses. The hypotheses are used as parameters to form the phase-compensated phasors to phase compensate the correlation process. As such, the phase compensation can be applied to the received signals, the local frequency source (e.g., an oscillator), or the correlation result values. The hypotheses collectively form a search space within which each of the hypotheses is tested to determine a preferred hypothesis. By performing signal correlation using the SUPERCORRELATION™ technique, in some embodiments the signals are correlated over a long coherent integration period (e.g., one second or more to realize very accurate signal discrimination). The result of the correlation process is a plurality of phase-compensated correlation results-one phase-compensated correlation result value for each hypothesis for each received signal. The reflected signals from the transmitters are naturally synchronized to direct received signals. Any drift and perturbations in the transmitter oscillator are contained in all the reflected signals. The receiver oscillator can therefore easily be referenced against the transmitter oscillator using the line of sight signal or any of the reflected signals once the Doppler effect from the reflector motion has been accounted for in accordance with the present principles.

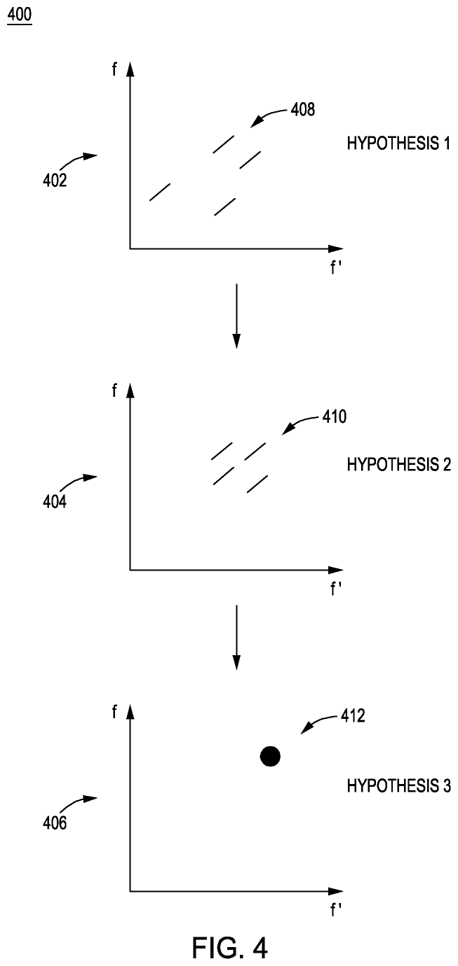

FIG. 4 is a graphical depiction of signal convergence resulting from the operation of the method of FIG. 3 in accordance with at least one embodiment of the present principles. That is, an iterative process of the present principles can be best understood through a graphic representation 400 as shown in FIG. 4. In the embodiment of FIG. 4, four GNSS satellite signals are reflected from a moving reflector. For simplicity and convenience, only two dimensional motion is considered in the embodiment of FIG. 4. In the graph 402 of FIG. 4, a first hypothesis of reflector motion is applied to the SUPERCORRELATION™ technique to determine frequency (f) and frequency rate (f′) of the four signals. Note the plot 408 for each signal is elongated by phasor noise and are not convergent to a specific frequency and frequency rate. Using a filtering algorithm as mentioned above, the motion hypothesis is improved at graph 404 to converge the signal plot 410. Finally, after a plurality of iterations, at graph 406, the frequency/frequency rate plot 412 has all four signals converged upon a single frequency/frequency rate. The motion hypothesis that attains the convergence is the correct motion model. As such, the velocity, position and heading of the reflector is now known and an accurate path length of the reflected signal can be determined.

Referring back to the method 300 of FIG. 3, in some embodiments at 310, the correlation results can be processed, as described above with respect to FIG. 4, to find the “best” or optimal result for each received signal. In some embodiments, a joint correlation output is produced as a function (e.g., summation) of the plurality of correlation results resulting from all the hypotheses and all received signals. The joint correlation output can be a single value or a plurality of values that represent the parameter hypotheses (preferred hypotheses) that provide an optimal or best correlation output.

In some embodiments, a cost function can be applied to each set of correlation values for each received signal to find the optimal correlation output corresponding to a preferred hypothesis or hypotheses. The joint correlation output reveals the frequency and frequency rate offset between the receiver oscillator and the transmitter oscillator, allowing the receiver to be synchronized to the transmitter accordingly.

In some embodiments, rather than using the largest magnitude correlation value, other test criteria can be used. For example, a progression of correlations can be monitored as hypotheses are tested and a cost function can be applied that indicates the best hypotheses when the cost function reaches a minimum (e.g., a small hamming distance amongst peaks in the correlation plots). As such, in some embodiments the joint correlation output can be a joint correlation value or a group of values. Alternatively or in addition, in some embodiments, additional hypotheses can be tested in addition to the DoA hypotheses to, for example, ensure the motion compensation (i.e., speed and heading) is correct.

Referring back to the method 300 of FIG. 3, at 316, the path length of the reflected signals is determined. The method 300 can proceed to 318.

At 318, using the path length, the time and phase of the reflected signal(s) is adjusted to compensate for the additional path length of the reflected signal as compared to the path length of a direct signal. The method 300 can proceed to 320.

At 320, once adjusted, the code phase of both reflected signals and direct signals can be used in a conventional position computation to accurately determine the position of the user equipment. In some embodiments, the compensated signals can be used to accurately determine time. The method 300 can proceed to 322.

At 322, position and/or accurate time reference can be output (e.g., actual time of day based on knowing the frequency offset of the clock that is determined using supercorrelation). In accordance with the present principles, because the clock is accurate over long periods of time, the signal processing is capable of integrating over long periods. Consequently, very low signal to noise level signals can be used in the position solution of the present principles.

The method 300 can end at 324.

In some embodiments, to improve the accuracy in position and/or time, the method 300 can be iterated using a prior position/time as a starting hypothesis. With each pass through the method 300, the position/time accuracy can be improved.

In some embodiments, in the method 300 the motion of the moving reflector is determined from information received from a database comprising motion information of at least one moving reflector.

In some embodiments, in the method 300 the motion of the moving reflector is determined from information derived from at least one of maps that constrain the reflector to specific paths and known speed limits that constrain the reflector to specific speeds.

In some embodiments, in the method 300 the motion of the moving reflector includes at least one of a position, a velocity and a heading of the moving reflector.

In some embodiments, the method 300 can further include determining a time delay of a reflected signal compared to a direct signal using information regarding a location of a transmitter of the direct and reflected signals, the motion of the reflector, and at least an estimate of the position of the user equipment.

In some embodiments, in the method 300 a ray tracing model is used to determine the propagation path of at least one of the direct signal and the reflected signal and to compare the path length of the direct signal path and the reflected signal path.

In some embodiments, in the method 300 a cost function is used to determine the preferred hypothesis.

In some embodiments of the present principles, an apparatus for determining position and/or time for user equipment using radio signals that are reflected from moving reflectors includes at least one processor and at least one memory for storing programs and/or instructions. In such embodiments, when the programs and/or instructions are executed by the at least one processor, the apparatus is caused to perform operations including receiving a plurality of reflected signals transmitted from a transmitter and reflected by at least one reflector, where each of the plurality of reflected signals has a different propagation path, determining a motion of the at least one reflector, generating a plurality of phasors sequences, where each phasor sequence represents a hypothesis based on motion of the at least one reflector and a user equipment position estimate for each of the plurality of the received signals, compensating the received signals, a plurality of local signals or correlation results from correlating the received signals with the local signals using the plurality of phasor sequences based on the plurality of hypotheses regarding the reflector motion and the user equipment position estimate to generate a plurality of compensated correlation results, identifying a preferred hypothesis in the plurality of hypotheses for each received signal that optimizes at least one correlation result in the plurality of compensated correlation results, and using the optimized at least one correlation result to determine a user equipment position and/or time (e.g., actual time of day based on knowing the frequency offset of the clock that is determined using supercorrelation).

In some embodiments, a non-transitory computer readable medium has stored thereon at least one program, the at least one program including instructions which, when executed by a processor, cause the processor to perform a method for determining position and/or time for user equipment using radio signals that are reflected from moving reflectors including receiving a plurality of reflected signals transmitted from a transmitter, where each of the plurality of reflected signals has a different propagation path, determining a motion of a moving reflector, generating a plurality of phasors sequences, where each phasor sequence represents a hypothesis based on reflector motion and a user equipment position estimate for each of the plurality of the received signals, compensating the received signals, a plurality of local signals or correlation results from correlating the received signals with the local signals using the plurality of phasor sequences based on the plurality of hypotheses regarding the reflector motion and the user equipment position estimate to generate a plurality of compensated correlation results, identifying a preferred hypothesis in the plurality of hypotheses for each received signal that optimizes at least one correlation result in the plurality of compensated correlation results, and using the optimized at least one correlation result to determine a user equipment position and/or time.

Embodiments of the present principles were described above including instances in which motion information was available for the moving reflectors. In embodiments of the present principles in which motion information is not available, the user equipment can determine Doppler and Doppler rate for the reflected signals. Such information provides situational awareness information such as moving reflector speed (i.e., traffic moving slowly), number of moving reflectors near the user equipment indicating traffic congestion, and the like.

Alternatively or in addition, in some embodiments, some knowledge of the moving reflector motion can be received from other sources, such as maps, that constrain reflective vehicles to specific paths and known speed limits that constrain reflective vehicles to certain speeds. Such information can provide guidance to define the motion information of nearby moving reflectors.

Alternatively or in addition, in some embodiments, the user equipment can share information regarding moving reflectors, situational awareness, etc., to facilitate understanding of a local environment. In such embodiments, the additional information about the environment can be used to constrain the number and density of hypotheses used in the SUPERCORRELATION™ computations of the present principles.

Embodiments of the present principles can be used to generate maps describing radio signal reflective surface (e.g., room maps, urban canyon city maps, etc.). Alternatively or in addition, in some embodiments, the techniques described herein can be used to confirm the accuracy of apriori provided surface maps. Consequently, inaccurate provided maps can be identified for correction and/or can be restricted from use in position location calculations.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with a computing device via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices).

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present principles, other and further embodiments of the present principles can be devised without departing from the basic scope thereof, and the scope thereof is determined by the claims that follow.

1. A method for determining a position and/or a time for user equipment using radio signals that are reflected from moving reflectors, comprising:
receiving a plurality of reflected signals transmitted from a transmitter, where each of the plurality of reflected signals has a different propagation path;
determining a motion of a moving reflector;
generating a plurality of phasors sequences, where each phasor sequence represents a hypothesis based on reflector motion and a user equipment position estimate for each of the plurality of the received signals;
compensating the received signals, a plurality of local signals or correlation results from correlating the received signals with the local signals using the plurality of phasor sequences based on the plurality of hypotheses regarding the reflector motion and the user equipment position estimate to generate a plurality of compensated correlation results;
identifying a preferred hypothesis in the plurality of hypotheses for each received signal that optimizes at least one correlation result in the plurality of compensated correlation results; and
using the optimized at least one correlation result to determine a user equipment position and/or time.

2. The method of claim 1, wherein the motion of the moving reflector is determined from information received from a database comprising motion information of at least one moving reflector.

3. The method of claim 1, wherein the motion of the moving reflector is determined from information derived from at least one of maps that constrain the moving reflector to specific paths and known speed limits that constrain the moving reflector to specific speeds.

4. The method of claim 1, wherein the motion of the moving reflector includes at least one of a position, a velocity and a heading of the moving reflector.

5. The method of claim 1, further comprising determining a time delay of a reflected signal compared to a direct signal using information regarding a location of a transmitter of the direct and reflected signals, the motion of the moving reflector, and at least an estimate of the position of the user equipment.

6. The method of claim 5, wherein a ray tracing model is used to determine a propagation path of at least one of the direct signal and the reflected signal and to compare a path length of a path of the direct signal and a path of the reflected signal.

7. The method of claim 1, wherein a cost function is used to determine the preferred hypothesis.

8. An apparatus for determining a position and/or a time for user equipment using radio signals that are reflected from moving reflectors, comprising:
at least one processor and at least one memory for storing programs and/or instructions that, when executed by the at least one processor, causes the apparatus to perform operations comprising:
receiving a plurality of reflected signals transmitted from a transmitter and reflected by at least one movin reflector, where each of the plurality of reflected signals has a different propagation path;
determining a motion of the at least one moving reflector;
generating a plurality of phasors sequences, where each phasor sequence represents a hypothesis based on motion of the at least one moving reflector and a user equipment position estimate for each of the plurality of the received signals;
compensating the received signals, a plurality of local signals or correlation results from correlating the received signals with the local signals using the plurality of phasor sequences based on the plurality of hypotheses regarding the moving reflector motion and the user equipment position estimate to generate a plurality of compensated correlation results;
identifying a preferred hypothesis in the plurality of hypotheses for each received signal that optimizes at least one correlation result in the plurality of compensated correlation results; and
using the optimized at least one correlation result to determine a user equipment position and/or time.

9. The apparatus of claim 8, wherein the motion of the moving reflector is determined from information received from a database comprising motion information of at least one moving reflector.

10. The apparatus of claim 8, wherein the motion of the moving reflector is determined from information derived from at least one of maps that constrain the reflector to specific paths and known speed limits that constrain the moving reflector to specific speeds.

11. The apparatus of claim 8, wherein the motion of the reflector includes at least one of a position, a velocity and a heading of the moving reflector.

12. The apparatus of claim 8, wherein the apparatus is further configured to determine a time delay of a reflected signal compared to a direct signal using information regarding a location of a transmitter of the direct and reflected signals, the motion of the reflector, and at least an estimate of the position of the user equipment.

13. The apparatus of claim 12, wherein a ray tracing model is used to determine the propagation path of at least one of the direct signal and the reflected signal and to compare the path length of a path of the direct signal and a path of the reflected signal.

14. The apparatus of claim 8, wherein a cost function is used to determine the preferred hypothesis.

15. A non-transitory computer readable medium having stored thereon at least one program, the at least one program including instructions which, when executed by a processor, cause the processor to perform a method for determining a position and/or a time for user equipment using radio signals that are reflected from moving reflectors, comprising:
receiving a plurality of reflected signals transmitted from a transmitter, where each of the plurality of reflected signals has a different propagation path;
determining a motion of a moving reflector;
generating a plurality of phasors sequences, where each phasor sequence represents a hypothesis based on reflector motion and a user equipment position estimate for each of the plurality of the received signals;
compensating the received signals, a plurality of local signals or correlation results from correlating the received signals with the local signals using the plurality of phasor sequences based on the plurality of hypotheses regarding the reflector motion and the user equipment position estimate to generate a plurality of compensated correlation results;
identifying a preferred hypothesis in the plurality of hypotheses for each received signal that optimizes at least one correlation result in the plurality of compensated correlation results; and
using the optimized at least one correlation result to determine a user equipment position and/or time.

16. The non-transitory computer readable medium of claim 15, wherein the motion of the reflector is determined from information received from a database comprising motion information of at least one reflector.

17. The non-transitory computer readable medium of claim 15, wherein the motion of the reflector is determined from information derived from at least one of maps that constrain the reflector to specific paths and known speed limits that constrain the reflector to specific speeds.

18. The non-transitory computer readable medium of claim 15, wherein the motion of the reflector includes at least one of a position, a velocity and a heading of the reflector.

19. The non-transitory computer readable medium of claim 15, further comprising determining a time delay of a reflected signal compared to a direct signal using information regarding a location of a transmitter of the direct and reflected signals, the motion of the reflector, and at least an estimate of the position of the user equipment.

20. The non-transitory computer readable medium of claim 19, wherein a ray tracing model is used to determine the propagation path of at least one of the direct signal and the reflected signal and to compare the path length of a path of the direct signal and a path of the reflected signal.
